(19) United States
(12) Patent Application Publication
(10) Pub. No.: US 2026/0230109 A1
(43) Pub. Date: Aug. 6, 2026

(54) PULSE SYNCHRONIZATION

(71) Applicant: DUTCH INNOVATION B.V., ED Oss (NL)

(72) Inventors: Freerk DIJKSTRA, ED Oss (NL); Johannes Otto ROOYMANS, ED Oss (NL)

(73) Assignee: DUTCH INNOVATION B.V., ED Oss (NL)

(21) Appl. No.: 19/145,978

(22) PCT Filed: Dec. 14, 2023
(86) PCT No.: PCT/NL2023/050659

§ 371 Date: Jul. 7, 2025

(30) Foreign Application Priority Data
Jan. 6, 2023 (NL) 2033919

(51) Int. Cl. H04B 1/7073; H04B 1/7075

(52) U.S. Cl. CPC H04B 1/70735; H04B 1/70754

(57) ABSTRACT

A method for synchronizing a device to a pulse signal. Application is found in wireless communication for detecting and synchronizing data pulses that would otherwise be imperceptible. Using this method, the transceiver can be ultra low power and low cost. The method allows the receiving unit to synchronize wirelessly to the received signal, which consists of pulses spread across a code period. The position of the pulses within the code period is defined by a pseudo-random code, which is orthogonal and non-correlated to minimize interference with other channels or devices using random codes. The method does not require an external clock signal for synchronization. It may include a combined transceiver unit with a Li-Fi receiver or an ultra-wideband (UWB) receiver as the first receiver. The method involves shifting an integration window with respect to the signal using multiple delay values. For each delay value, an integration value is indicating the delay to be selected. The selected delay can be used to implement low-power, high-density, both stationary and mobile ad-hoc mesh networks that provide dynamic ranging, localization, and spatial awareness.

### FIELD

The present invention relates to a method for synchronizing a receiving unit of a device to an electromagnetic signal including pulses. The present invention further relates to a device comprising such a receiving unit, a method of operating such a device, and a system comprising such a device.

### BACKGROUND

Pulse-based electromagnetic signals can be used to transmit information through a medium, such as air. Typically, this involves a transmitting unit that embeds information on such a signal and transmits it, and a receiving unit that receives the signal and extracts information from it. In one example, a pulse timing may be set by the transmitter with which information is embedded in the signal. For the receiver to accurately extract information from the signal after receiving it, synchronization may be necessary.

Methods for synchronizing receiving units are known in the art. For example, the transmitting unit and receiving unit may be synchronized by means of a wired connection. However, a wired connection may not always be possible, for example in mobile applications. In another example, a clock signal may be provided by the transmitting unit to the receiving unit as an external signal, though such an approach would further complicate the design of the receiving unit.

Further to the above, devices and systems involving the transmission of electromagnetic signals inherently cause electromagnetic interference (EMI). At the same time, such devices must comply with electromagnetic compatibility (EMC) guidelines, restricting the maximum transmitted electromagnetic energy in various frequency bandwidths. As a result, for most communication devices and systems, measures are typically required to limit electromagnetic energy emission at the transmitting side around the operating frequency, and to be able to communicate at relatively low signal to noise ratios, such as in low-power conditions at the receiving side or in the presence of significant electromagnetic noise.

### SUMMARY

It is an object of the present invention to provide a method for synchronizing a receiving unit of a device to an electromagnetic signal including pulses, for example even in low-power conditions.

According to an aspect of the present invention, a method for synchronizing a receiving unit of a device to an electromagnetic signal is provided, in which the signal comprises pulses spread across a length of time referred to as a code period, and in which the position of the pulses within the code period is defined by a pseudo-random code. The method comprises, by the device: a) receiving the signal; b) defining an integration window having a length corresponding to the code length, and comprising integration intervals at positions within the integration window defined by the pseudo-random code, each integration interval comprising a first integration range and a non-overlapping second integration range; c) for each of a plurality of different delay values, shifting the integration window with respect to the signal with the respective delay value and determining a corresponding integration value based on a difference between a first integral of the signal over the first integration ranges and a second integral of the signal over the second integration ranges; d) selecting a delay value among the plurality of delay values corresponding to an extreme of the determined integration values; and e) synchronizing the receiving unit to the signal using said selected delay value.

The signal defined above may for example be provided by a transmitting unit with which the receiving unit should synchronize. Such a transmitting unit may be an external element, though this need not be the case.

Within the context of the present invention, the term ‘code period’ may refer to a length of time in which the signal includes pulses that are distributed over that length of time. In the signal, the code period has predefined pulse positions in accordance with the pseudo-random code. The pulse positions define a pattern. The pattern is typically chosen so that it does not line easily or often line up with patterns of different codes of other transmitters. In the ideal case for two different codes of the same code period and code length, only one pulse position is equal even if the two patterns are shifted with respect to each other by an arbitrary amount.

The code may be repeated, e.g. several times, to form the signal. The term ‘code length’ may refer to the number of pulses in a code period, i.e., the number of pulses in the pattern in the signal before the pattern repeats in a subsequent code period.

With a fixed pulse interval, spiked energy distributions may occur in the frequency spectrum, complicating the compliance with EMC guidelines and potentially causing interference with nearby channels at the same or a similar operating frequency. By providing the signal in accordance with the present invention, i.e., using a pseudo-random code to distribute the pulses in a defined code period, the energy of the electromagnetic signal can be better distributed in the frequency spectrum. Furthermore, using orthogonal pseudo-random codes having a limited cross-correlation can prevent or limit interference with other devices using a different, e.g. orthogonal pseudo-random code.

Further to the above, the method according to the present invention allows the receiving unit to synchronize wirelessly to the signal without the need for an external clock signal. In fact, synchronization takes place based on the signal itself, preferably based on only the signal itself and knowledge of the pseudo-random code. Using a known pseudo-random code, the receiving unit can define an integration window having integration intervals that match an expected pulse pattern in the signal and find the delay value at which the integration intervals match the pulse positions. In doing so, the delay value can be used to synchronize the receiving unit to the signal, since the start of the pulse pattern in the signal can now be identified.

Finally, the use of two non-overlapping integration intervals in a bi-phase manner, i.e., either defining the second integral to have an opposite sign to the first integral or by subtracting the second integral from the first integral thereby doing effectively the same, enables accurate detection of the pulse position even in low signal to noise ratio conditions, such as low-power conditions or in the presence of significant noise. The underlying theory here is that noise present in the signal is added in each integral, and cancels out between the first and second integral when they are subtracted. The pulse however, does not cancel out because it can be present predominantly in only one integration range, and therefore is not effected by the subtraction the same way that noise is.

The determined integration value is a stochastic variable. The value of this parameter can be used as a measurement for synchronicity, as it is maximal (or minimal) when the correct delay has been applied. Moreover, the value of the parameter can be used as an indicator for whether or not a pulse was present in the respective integration range(s). In both cases, it is possible to perform the same calculation repeatedly over a number of pulses, in order to further reduce noise and derive a more confident parameter.

In case pulses are used for modulation, it is therefore possible to send a similar pulse several times for each bit, each pulse thereby forming a chip. The amount of pulses employed for sending a single bit is called the chip rate. Typically, the chip rate is chosen depending on the signal to noise ratio at the receiver by selecting a chip rate that is sufficiently large, but as small as possible to still allow a sufficiently accurate demodulation.

It is advantageous if the signal includes a pattern of pulses for several integration windows, i.e. multiple code lengths. Accordingly, the integration value can be determined for each delay one after the other. Analog processing means may be provided that perform the required analogue processing to determine the integration value, wherein the delay is set as a parameter in the analogue processing means and changed for every delay, one after the other, while the signal is received continuously. This same method may be used whenever integration values are to be determined such as when fine-tuning according to the method described below.

It is noted that for certain applications, it is sufficient to known the selected delay value. Accordingly, step e) is not strictly necessary for those applications. As an example, the selected delay value may be used to determine a distance between an transmitter and the device in ranging or localization applications.

The method may further comprise, prior to or after step e), fine-tuning the selected delay value by: f) defining a plurality of different fine delay values deviating from the selected delay value; g) selecting at least one integration interval among the plurality of integration intervals; h) for each fine delay value, shifting the at least one selected integration interval with respect to the signal according to the respective fine delay value, and determining a corresponding fine integration value based on a difference between a first integral of the signal over the first integration range(s) of the selected at least one integration interval and a second integral of the signal over the second integration range(s) of the selected at least one integration interval; and i) selecting, as the fine-tuned delay value, a fine delay value among the plurality of fine delay values corresponding to an extreme of the determined fine integration values.

For some applications, a high synchronization accuracy is desired. To that end, the number of delay values used in step c) may be increased, at the same time reducing the difference between each delay, i.e. using more fine delays from the beginning. However, it may not be feasible to arbitrarily increase this number as that may significantly impact the required synchronization time. To address this, a coarse delay estimation can be made in step d) using a first set of delay values shifting the integration window along the code period. After determining a coarse delay value, a fine-tuning process according to steps f)-i) can be performed locally near the determined coarse delay value to obtain a fine-tuned delay value. In doing so, the desired synchronization accuracy can be achieved with significantly limited synchronization time and computational complexity. Of course this process may be iterated if further fine tuning is desired, although a two-pass process may be advantageous.

The selected at least one integration interval may be a plurality of selected integration intervals, the amount of which being smaller than the code length. In particular, the plurality of integration intervals may equal a chip rate used for modulation. Accordingly, the amount of selected integration intervals may be a divisor of the code length.

It is noted that it is preferable if the chip rate is smaller than the code length. In particular, the chip rate and/or code length may be chosen so that the code length is a multiple of the chip rate. In case the chip rate equals the code length, the selected at least one integration interval may be all integration intervals in the integration window. It is however preferable to have a relatively large code length to limit noise, whilst performing fine synchronization over a relatively small chip rate.

Alternatively, it is possible the at least one integration interval is exactly one integration interval among the plurality of integration intervals in the integration window. In other words, after determining a coarse delay value based on all the integration intervals of one code, i.e. those that match the pulse pattern, the fine-tuning of the delay value need not be performed based on integrating each pulse of in code period. Instead, since the coarse delay value already provides a coarse synchronization of the receiving unit to the signal, the delay value can be fine-tuned by observing only a single pulse in the code period. This further limits the computational complexity of the fine-tuning for the delay value.

It is noted that using a two-pass synchronization, in which coarse synchronization is followed by fine tuned synchronization, may be especially advantageous when a pseudo-random code is used. After all, according to the invention integration is performed over different ranges spread across the entire code length. The delay values therefore needs to be sufficient to shift the integration window (almost) an entire code period, which is comparatively long with respect to the desired accuracy of synchronization. As such, choosing sufficient delay values to achieve fine-tuned synchronization in one pass may be impractical or prohibitively expensive in terms of calculation effort.

A width in time of the first and second integration interval may correspond to a width in time of the pulses in the signal. As a result, a maximum integration value can be obtained when the integration interval covers an entire pulse in the interval, thereby limiting the effect of noise on the integration value, for instance limiting it to the practical maximum.

The receiving unit may comprise a first receiver. A typical receiver comprises an antenna that can receive the electromagnetic signal and convert the signal into an electric signal, and processing circuitry for processing the electric signal from the antenna. Synchronization is useful for accurate processing of said electric signal. To that end, step e) may comprise synchronizing the first receiver.

The electric signal corresponds to the received electromagnetic signal before reception, at least in phase. Accordingly, the current disclosure may be read as if synchronizing to the electric signal equally well, as the synchronization would be the same. After all, synchronizing to the electromagnetic signal implies synchronizing to the electric signal and vice versa.

In a further embodiment, step a) may be performed by the first receiver. Alternatively, the receiving unit may comprise a second receiver, and step a) may be performed by the second receiver. In an even further embodiment, step e) may further comprise synchronizing the second receiver. For example, the same or a similar delay value may be selected for the second receiver and for the first receiver.

Additionally, the step a) may be performed by the first and second receiver together. In this case, both receivers may produce corresponding electric signals, that may both be processed similarly to obtain integrals required for determining the delay.

In all cases, the first and second receivers may be of a different type. As a non limiting example, one receiver may be an UWB receiver while the other receiver is a LiFi receiver. Using receivers of a mutually different type may have several advantages, for instance allowing selection of an appropriate receiver given certain circumstance that affect transmission.

If the receivers are of a different type, and if they are both used in step a), an additional advantage may be obtained. In particular, it becomes possible to receive two signals at the same time, the signals interfering with each other only to a limited extent by virtue of them being of a different kind. Accordingly, less time may be needed to perform synchronization. After all, more pulses can be received at the same time, thereby reducing the time needed to receive sufficient pulses for synchronization.

Whilst these advantages may be increased by using even more receivers, using a LiFi receiver and an UWB receiver may be advantageous, since together these receivers allow a very versatile use of the device.

In any case, it is preferred if the signals received by each receiver is are in phase, i.e. synchronized, with each other. This could be the case if both receivers receive the same signal. If the receiver receive a different signal, such as an UWB signal on the one hand and a LiFi signal on the other hand, these signals are preferably synchronous.

Regardless of whether the first or second receiver or both are used in step a), the corresponding electric signal(s) produced by the receiver(s) may be processed at least in part by the same components. In that case, the current disclose benefits from the fact that different receivers do not require different components for processing, leading to a more elegant design of the device.

The code period may be divided into a plurality of time-intervals, each time-interval comprising a plurality of sub-intervals, wherein each time-interval comprises a pulse positioned in one of the plurality of sub-intervals thereof in accordance with the pseudo-random code.

According to another aspect of the present invention, a method for operating a device comprising a receiving unit is provided. The method comprises synchronizing the receiving unit using the method defined above, and receiving, using the synchronized receiving unit, a second signal including pulses, said second signal being synchronous to the signal.

It is noted that, after synchronization, the original signal used in the synchronization method may no longer be necessary. To that end, the external transmitter may first transmit the signal for synchronization of the receiving unit, and subsequently the second signal for further application such as communication. Since the signal and the second signal may originate from a same source or may originate from synchronized sources, providing the second signal as being synchronous to the synchronization signal may easily be achieved.

The method may further comprise determining integration values for a plurality of consecutive pulses of the second signal based on the selected delay value and one or more delay values deviating therefrom to determine a direction and optionally a magnitude in which the selected delay value should be adjusted to maintain synchronicity, and adjusting the selected delay value by the determined amount.

In case the signal is modulated to include bits using a chip rate, integration values may be determined for N consecutive bits, i.e. for N times the chip rate. N is preferably three. The delay values deviating from the selected delay value may be deviating in opposing directions.

The integration values may be determined as was explained in relation to synchronization or fine-tuning the delay.

Adjusting the selected delay as described herein may be used to compensate for clock drift, by shifting the selected delay to the delay that corresponds to the higher integration value. Accordingly, the device does not require a particularly accurate clock thereby removing constraints on sourcing and costs.

The required correction may be used for other applications as well. In particular, it is possible to determine clock skew and to compensate for it.

More in particular, if the device is moved with respect to a transmitter of the signal, the required correction is a measure for the change in distance between the transmitter and the device. Accordingly, once the above-mentioned direction and magnitude have been determined, a mutual distance or change in mutual distance may be calculated. The method may thus include ranging based on the determination of the required delay.

The second signal may be a data signal, and the method may further comprise processing the data signal to extract data therefrom. For example, a modulation scheme such as on-off-keying, ‘OOK’, may be employed for the data signal to embed data therein, and the method may comprise demodulating the data signal.

The second signal may be a reflected by a target object. In that case, the method may comprise determining a relative distance between the device and the target object based on the selected delay value, for instance based on a predetermined position of the transmitter of the signal. Furthermore, the device may further comprise a transmitting unit, and the method comprises, by the transmitting unit, transmitting the signal.

The transmitting unit and the receiving unit may be combined in a transceiver unit, thereby effectively constituting a monostatic radar.

It is noted that in ranging, radar and localization applications, the selected delay may be sufficient to determine a relative distance between transmitter and receiver, as long as that distance is within certain bounds. In the context of this application, the expected signal strength is expected to pose a stricter limit on the communication distance, so that said bounds may not be relevant. Moreover, it is noted knowledge of the position of the transmitter with respect to the receiver may be used to determine the position of a target object reflecting the signal.

When the position of one or more transmitters is known, the method may further comprise determining a position or change in position of the device using the selected delay and the position of the one or more transmitters. The transmitters may be mutually synchronized.

It is noted the transmitters need not be synchronized when the device comprises a transmitter and a receiver, for instance a transceiver. In such a case the device and an external anchor can determine their mutual distance by synchronizing the device to a request sent by the anchor, and by sending a response from the device, or vice versa. The required delay at the anchor or device then forms a measure for the mutual distance. The method may therefore include sending a response that in synchronized to the signal after the device has been synchronized to the signal.

As described above, the receiving unit may comprise a first receiver. The first receiver may be a Li-Fi receiver or an ultra-wideband, ‘UWB’, receiver, preferably a Li-Fi receiver.

The device may also comprise a second receiver in addition to the first receiver. In a further embodiment, the method may further comprise receiving, by the second receiver, the second signal using the selected delay value or, if applicable, the fine-tuned delay value selected for the first receiver. For example, the second receiver may be a Li-Fi receiver or an UWB receiver, preferably an UWB receiver.

As an alternative to providing a second receiver, a receiver may be provided that is receptive to signals of different kinds, such as a receiver that is receptive to UWB and Li-Fi signals. In such a case, the device could be configured to be receptive to UWB during a first period of time, and receptive to Li-Fi during a second, different period of time, by using the same receiver.

The first receiver may have a first communication range and the second receiver may have a second communication range greater than the first communication range. As a non-limiting example, UWB signals usually carry further than Li-Fi signals of comparable strength. In particular UWB may not require line-of-sight, whereas Li-Fi does. The second signal may be received from an external object or external device. The method may include, by the device, selecting one or both of the first receiver and the second receiver to receive the second signal when the external object or external device is within the first communication range, and select the second receiver to receive the second signal when the external object or external device is within the second communication range but not within the first communication range.

The pulses in the second signal may be spread across a second code period, wherein a number of pulses in the code period for the signal may be equal to or larger than a number of pulses in the second code period for the second signal. Accordingly, the code length of the second code may be larger than a code length of the first code.

In some cases, the code length of the second code has a certain minimum based on e.g. compliance requirements. The second code may therefore be relatively long. By providing a shorter first code, and synchronizing using the first code, synchronization may be performed more quickly. At this time, compliance requirements may not be as stringent since synchronization is likely to take place only in a relatively small portion of the total time.

According to another aspect of the present invention, a device is provided comprising a receiving unit. The device is configured to perform the method according to any of the embodiments defined above. In a further embodiment, the device may further comprise a transmitting unit.

According to another aspect of the present invention, a localization system is provided. The system comprises a device as defined above, and a plurality transmitters. The position of the transmitters is predetermined and known at the device. The transmitters may be synchronized to each other, or they may operate at a constant phase difference. The transmitters are each configured to transmit a respective signal comprising pulses spread across a length of time referred to as a code period, wherein a position of the pulses within the code period is defined by a pseudo-random code. The device is configured to determine the delay required to synchronize the receiving unit to each of the plurality of transmitters using the method as defined in any of embodiments described above, and to determine, based on a difference between the selected delays corresponding to each transmitter, a position of the device relative to the plurality of transmitters.

It is noted that the delay may be determined without actually synchronizing the device, i.e. step e) need not be performed.

According to another aspect of the present invention, a localization system is provided. The localization system includes a device as described-above, and one or more transceivers. The device or each of the one or more transceivers is configured to transmit a respective signal comprising pulses spread across a length of time referred to as a code period, wherein a position of the pulses within the code period is defined by a pseudo-random code, the signal constituting a request. The other of the device or the one or more transceivers is configured to synchronize to the signal using the method as defined hereabove. After synchronizing, the other of the device or the one or more transceivers is configured to transmit to the device or the one or more transceivers, a further signal comprising pulses, said further signal being synchronized to the signal, as a response. The device or the one or more transceivers are configured to determine a delay required to synchronize to the further signal according to the method as described above, and to determine a mutual distance between the device or the one or more transceivers on the one hand and the other of the device and the one or more of transceivers on the other hand based on the required delay.

Using this system of request and synchronized response, the delay value required for synchronization is a measure for the mutual distance. Accordingly, range method may be performed, which allows e.g. localization when the location of the one or more transceiver units or the device is known. In case multiple transceivers are used, the position of the device may be determined based on the required delay for each of the transceivers collectively.

It is noted that the required delay may be determined without actually synchronizing the device, i.e. step e) need not be performed.

### DETAILED DESCRIPTION

Next, the present invention will be described in more detail with reference to the appended drawings, wherein:

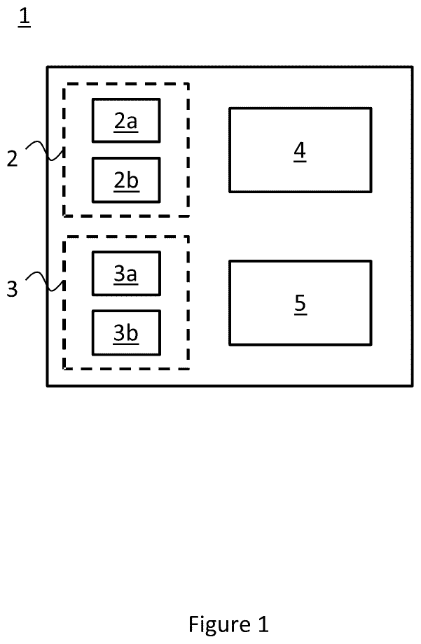

FIG. 1 is a schematic diagram of a device according to an embodiment of the present invention;

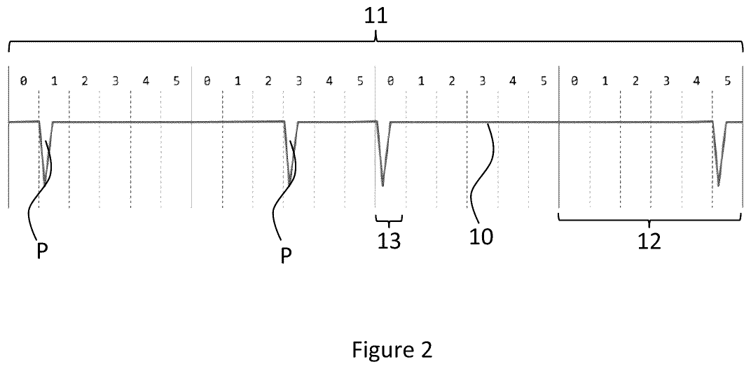

FIG. 2 is a signal diagram illustrating an example of a signal including pulses spread based on a pseudo-random code;

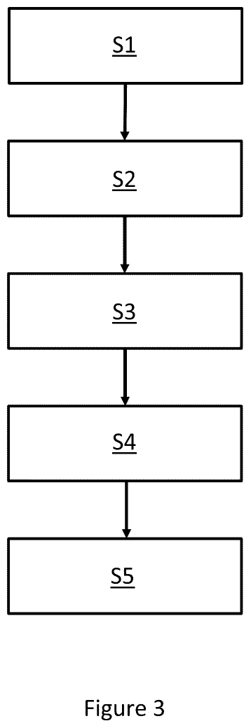

FIG. 3 is a flow diagram of a method for synchronizing a receiving unit of a device in accordance with an embodiment of the present invention;

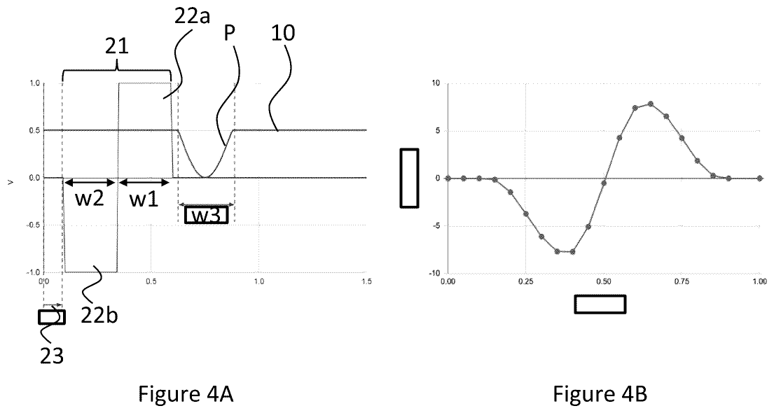

FIG. 4A is a signal diagram illustrating an example of a portion of an integration window;

FIG. 4B is a signal diagram illustrating an integration value as a function of delay corresponding to FIG. 4A;

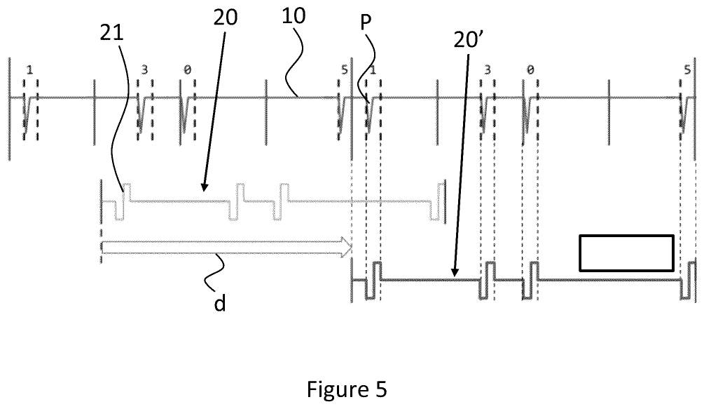

FIG. 5 is a signal diagram illustrating an example of an integration process of the signal of FIG. 2;

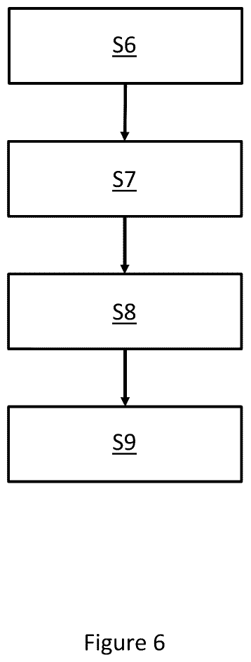

FIG. 6 is a flow diagram of a method for fine-tuning a delay value selected in the method of FIG. 2 in accordance with a further embodiment of the present invention;

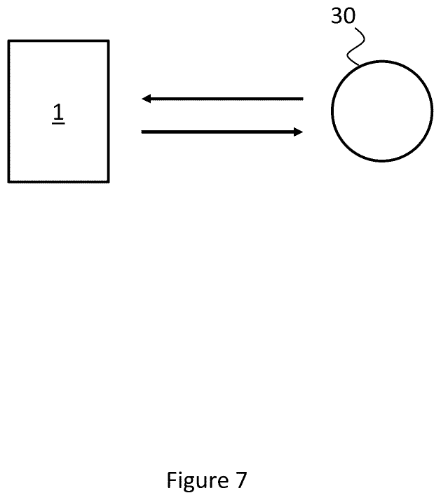

FIG. 7 illustrates an example of a ranging application for the device in accordance with an embodiment of the present invention;

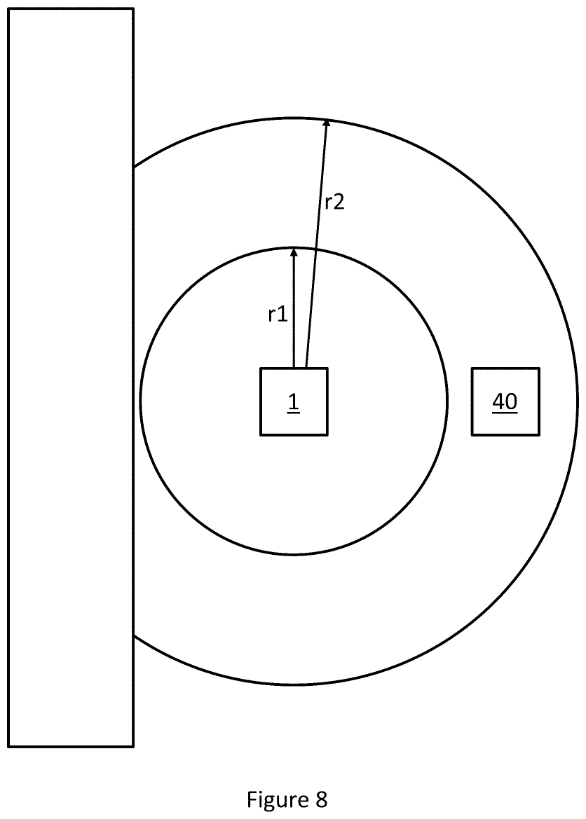

FIG. 8 illustrates an example of a communication application for the device in accordance with an embodiment of the present invention;

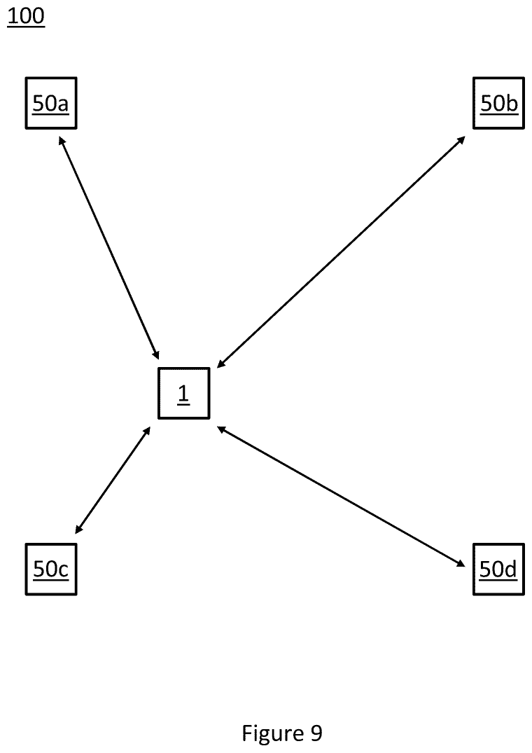

FIG. 9 illustrates a localization system according to an embodiment of the present disclosure; and

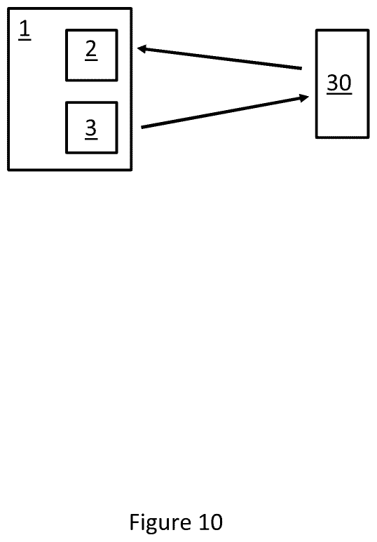

FIG. 10 illustrates a ranging application by a monostatic radar.

Hereinafter, reference will be made to the appended drawings. It should be noted that identical reference signs may be used to refer to identical or similar components.

In FIG. 1, a simplified schematic diagram of a device 1 according to an embodiment of the present invention is shown. Device 1 comprises a receiving unit 2. In this example, receiving unit 2 comprises a first receiver 2a and, optionally, one or more second receivers 2b. Although FIG. 1 shows only one second receiver 2b, any number of second receivers 2b may be comprised in receiving unit 2, or second receivers 2b may be completely omitted from device 1.

First receiver 2a and second receiver 2b may be typical receivers suitable for receiving and processing a pulse-based electromagnetic signal, as will be appreciated by the person skilled in the art. To that end, although not shown in the figures, first receiver 2a and second receiver 2b may comprise an antenna or other elements capable to convert the electromagnetic signal into an electrical signal. Processing circuitry may be provided as part of the receivers 2a, 2b, or may be provided as part of the receiving unit 2. Specifically, processing circuitry may be provided for both receivers, so that signals received using each of the receivers can be processed using the same processing circuitry. The processing circuitry may comprise e.g. a demodulator, a mixer, a clock signal generator, and the like. The processing circuitry may be analog or digital, or may be implemented in a mixed-signal approach. In an embodiment, first receiver 2a is an ultra-wideband (UWB) receiver, which is a pulse-based receiver operating in the radio frequency (RF) range and typically having an operational frequency in a range between 3-10 GHz. In an embodiment, the second receiver 2a is a Li-Fi receiver capable of receiving and processing electromagnetic signals in the form of (visible) light, for example using a photodiode or phototransistor. Accordingly, first receiver 2a and second receiver 2b need not be of the same type. Other embodiments are considered as part of the current disclosure, in which both receivers are of the same type, or of a mutually different type, possibly other than the above-described type.

Device 1 may further comprise one or more elements in addition to receiving unit 2 that are typically associated with or implemented in conjunction therewith. For example, device 1 may comprise a transmitting unit 3 for generating or receiving electrical signals and converting them into electromagnetic signals for transmitting them. Transmitting unit 3 may further comprise means for embedding information in the electrical signals, such as a modulator, such that the electromagnetic signals can convey said information to an external receiver. The modulation technique employed by transmitting unit 3 may correspond to that which receiving unit 2 is able to demodulate. Transmitting unit 3 may comprise a first transmitter 3a and/or a second transmitter 3b.

Although transmitting unit 3 is shown as being separate from receiving unit 2, this need not be the case. transmitting unit 3 and receiving unit 2 may be combined into a transceiver unit (not shown). For example, such a transceiver unit may comprise a first transceiver, comprising first receiver 2 and first transmitter 3a, and a second transceiver, comprising second receiver 2b and second transmitter 3b. In that case, first receiver 2a and first transmitter 3a may be of a same technology type, such as UWB or Li-Fi. Similarly, second receiver 2b and second transmitter 3b may be of a same technology type.

Furthermore, device 1 may comprise a processing unit 4, such as a central processing unit (CPU), for controlling elements of device 1, signal or data processing, performing computational tasks, storing or managing data, or the like. Device 1 may also comprise a memory 5 for storing programs, instructions for processing unit 4, various types of data, or the like.

Here, it is noted that the processing of signals received by receiving unit 2 may be processed internally to receiving unit 2, by processing unit 4, or a combination thereof. For example, first receiver 2a and/or second receiver 2b may be configured to receive a signal, and a remaining processing of the signal is performed by processing unit 4. Alternatively, first receiver 2a and/or second receiver 2b additionally demodulate the signal and provide the demodulated signal to processing unit 4 for further processing. or may even comprise dedicated processing circuitry for performing the methods according to the present invention defined herein.

Device 1 may be any type of electronic device comprising at least the receiving unit 2 described above, and the present invention is not limited to any particular shape, form or implementation. For example, device 1 may be a mobile terminal, such as a smartphone, a tablet, a laptop, or the like, and may comprise further elements typically included in such terminals, such as a camera, a microphone, a display screen, and so forth. In another example, device 1 may be a stationary device configured to be fixedly positioned or mounted.

Device 1 is configured to synchronize receiving unit 2 to an electromagnetic signal provided by an external device or received from an external object. For example, an external device transmits the signal towards device 1 in an attempt to initiate communication with device 1. In that case, synchronizing receiving unit 2 to the signal may have an identical or similar meaning to synchronizing receiving unit 2 to the external device. After synchronization, device 1 can be used in various applications, including but not limited to the applications described with reference to FIGS. 6-8 below. The process of synchronizing receiving unit 2 is further described below with reference to FIG. 2.

In FIG. 2, a simplified signal diagram is shown of a signal 10 to be synchronized to by receiving unit 2. For example, signal 10 is an electrical signal converted from an electromagnetic signal by receiving unit 2. Signal 10 includes pulses P that are spread across a length of time referred to as a code period 11. The positions of pulses P in code period 11 is defined by a pseudo-random code. A total number of pulses P in code period 11 may be referred to as a ‘code length’. For example, signal 10 as shown in FIG. 2 comprises four pulses P in code period 11 and thus has a code length of four. It will be appreciated by the person skilled in the art that any code length may be used. Code period 11 may be repeated in signal 10, meaning that a plurality of consecutive code periods 11 may be included in signal 10. For convenience, only two pulses are indicated with a reference P.

Signal 10 as shown in FIG. 2 may be referred to as a signal of the non-return-to-zero (NRZ) type using on-off keying (OOK) modulation. That is, in an idle state, the signal is present (‘on’), and in a pulse state the signal is not present (‘off’). For Li-Fi applications, this is for example achieved at the transmitter side by a lighting device, such as a light-emitting device (LED), which is on or active in an idle state and is briefly turned off to generate a light pulse. Alternatively, a signal of the return-to-zero (RZ) type may be used, in which the idle state is an ‘off’ state and the pulse state is an ‘on’ state. In that case, a pulse is generated by briefly switching the lighting device on.

In an embodiment, the pseudo-random code may be implemented in signal 10 as follows. Code period 11 is divided into a plurality of time intervals 12, each time interval including one pulse P. Moreover, each time interval 12 may include a plurality of sub-intervals 13 in which pulse P may be positioned. For example, as shown in FIG. 2, the first pulse of signal 10 may be positioned in a sub-interval with index ‘1’, the second pulse of signal 10 may be positioned in a sub-interval with index ‘3’, the third pulse of signal 10 may be positioned in a sub-interval with index ‘0’, and the fourth pulse of signal 10 may be positioned in a sub-interval with index ‘5’. The indexes of the sub-intervals collectively represent the pseudo-random code, which in this case is ‘1305’. However, this particular implementation of spreading pulses using a pseudo-random code is merely provided as an example and should not be construed as limiting to the present invention.

Signal information may be embedded in signal 10. For example, a binary value can be embedded in signal 10 by generating a pulse having a certain relative position of the pulse in signal 10. Such a modulation technique may be referred to as pulse-position modulation (PPM). For example, in a bit interval (e.g., sub-interval 13), pulse P may be positioned in a first half of the interval to indicate a bit value of ‘0’, or in a second half of the interval to indicate a bit value of ‘1’. However, it is noted that this is only provided as an example, and other methods of embedding information in the pulse-based signal are not excluded.

Since signal 10 is to be used for synchronization, a predefined bit pattern (such as repeatedly only the value ‘1’ or only the value ‘0’) may be used. After synchronization, data can be transmitted by modifying, by the external device, the positions of the pulses in accordance with the required bit pattern. For convenience, in FIG. 2, each pulse P is shown to be in a first half of their corresponding sub-interval 13, indicating a same bit value (e.g., the value ‘0’).

In FIG. 3, a flow diagram is shown of a method for synchronizing receiving unit 2 of device 1 to an electromagnetic signal. In the method, the signal comprises pulses that are spread across a code period, as described with reference to FIG. 2. The method comprises performing, by device 1, steps S1-S5 as described below, and may include further, optional steps described herein.

In step S1, device 1 receives, using receiving unit 2, the signal (e.g., signal 10 of FIG. 2) to which receiving unit 2 is to be synchronized. Here, synchronizing receiving unit 2 may refer to synchronizing first receiver 2a, synchronizing second receiver(s) 2b, or synchronizing both first receiver 2a and second receiver(s) 2b. Irrespective of which receiver(s) among first receiver 2a and second receiver(s) 2b is to be synchronized to the signal, receiving unit 2 may receive the signal using any of first receiver 2a and second receiver(s) 2b. For example, although second receiver 2b receives the signal, first receiver 2a may be synchronized using the method described herein.

In step S2, device 1 defines an integration window having a length corresponding to the code length, and comprising integration intervals at positions within the integration window defined by the pseudo-random code. Each integration interval comprises a first integration range and a non-overlapping second integration range.

In step S3, device 1 uses a plurality of different delay values by shifting, for each delay value, the integration window with respect to the signal by the respective delay value. For each delay value, a corresponding integration value is determined based on a difference between a first integral of the signal over the first integration ranges and a second integral of the signal over the second integration ranges. The determining of integration values, the integration window itself and the delay values are described below in more detail with reference to FIGS. 4A, 4B and 5.

In step S4, a delay value among the plurality of delay values used by device 1 may be selected as the selected delay value. Said selected delay value may correspond to an extreme of the determined integration values. For example, the selected delay value corresponds to a maximum (or minimum) integration value among the integration values determined based on the plurality of delay values. In particular, for said selected delay value, the position of the integration intervals match the positions of the pulses in the received signal.

Finally, in step S5, receiving unit 2 may be synchronized to the signal using the selected delay value. For example, the selected delay value may be used to define, for first receiver 2a and/or second receiver(s) 2b, a time instance at which the code period starts. This information can subsequently be used by said receiver to accurately retrieve information from the signal.

In the method described above with reference to FIG. 3, step S1 may be performed using receiving unit 2 (e.g., first receiver 2a and/or second receiver 2b), whereas step S2-S5 may be performed using processing circuitry in receiving unit 2, processing unit 4, or a combination thereof.

In FIG. 4A, a portion of signal 10 with pulse P is shown in a simplified signal diagram, with amplitude on the y-axis and time on the x-axis. Furthermore, a portion of an integration window including an integration interval 21 is overlaid in the signal diagram. As described above, integration interval 21 comprises a first integration range 22a and a non-overlapping second integration range 22b. An offset 23 is indicated using an arrow from the (arbitrary) x-axis origin to a start of integration interval 21.

First integration range 22a has a first width w1 in time and second integration range 22b has a second width w2 in time. First width w1 and second width w2 may be defined to be equal. Moreover, first width w1 and second width w2 may be defined to have a width corresponding to a typical pulse width w3 for the designated application.

As shown in FIG. 4A, second integration range 22b may have a sign opposite to that of first integration range 22a. For example, first integration range 22a may have a positive sign for integration, and second integration range 22b may have a negative sign for integration. In doing so, a difference between a first integral of signal 10 over first integration range 22a and a second integral of signal 10 over second integration range 22b can simply be determined by adding the first and second integral. Alternatively, first integration range 22a and second integration range 22b have the same sign, in which case the second interval can be subtracted from the first interval to determine the difference.

Signal 10 may be integrated using integration interval 21 for various offsets 23. An exemplary result thereof is shown in FIG. 4B, in which the x-axis represents a value of offset 23 and the y-axis represents a corresponding integration value. As shown in FIG. 4B, the integration value may exhibit a maximum when first integration window 22a overlaps maximally with pulse P, and may exhibit a minimum when second integration window 22b overlaps maximally with pulse P. Either or both of the corresponding values of offset 23 can be used to define a position in time of pulse P with respect to a start of the signal and can be used to synchronize receiving unit 2.

In FIG. 5, the concept shown in FIGS. 4A and 4B is extended to signal 10 of FIG. 2, which, as detailed above, includes a pulse train based on a pseudo-random code. Here, an integration window 20 is shown that comprises a plurality of integration intervals 21, the positions of which with respect to a start of integration window 20 are defined by the pseudo-random code. A length in time of integration window 20 corresponds to that of the code period (e.g., code period 11 of FIG. 2).

Since, for integration window 20, none of the integration intervals 21 overlap with any of the pulses of signal 10, a corresponding integration value after integrating over integration intervals 21 will roughly be equal to zero. Consequently, for a delay value d of zero, integration intervals 21 do not match the positions of pulses P in the code period.

Integration window 20 can be repeatedly shifted using a plurality of different delay values d (e.g., incremental values) and calculating corresponding integration values. Depending on the auto-correlation of the selected pseudo-random code, which is preferably as small as possible, the integration values may show small positive or negative peaks when some pulses are completely covered but others are not. However, eventually, a delay value d is reached at which integration intervals 21 and pulses P are maximally overlapping, i.e., when all pulses are covered. For this delay value d, an extreme (i.e., a maximum or minimum) can be observed in the integration value, which is indicative of where the code period in signal 10 starts. Said delay value can then be selected as the selected delay value for synchronizing receiving unit 2.

In this method, the accuracy (i.e., resolution) of the delay value is determined by a step or increment size in the delay value. That is, the more delay values are used between a value of zero and a value corresponding to the code length, the more accurate the resulting selected delay value is. However, it may not be desirable to arbitrarily increase the number of delay values used every time synchronization is needed, since that would prevent completion of synchronization within a reasonable time. In that regard, it is noted that the integration value for each delay may be determined one after the other, whilst the signal is being received. Thus, the signal may include a series of repeating pulses of considerable length, to allow repeated determination of integration values for each delay. Accordingly, if the amount of delay values is too large, the signal must include a very long series of repeating pulses, requiring a long time. In particular, the step size between delay values is preferably as large as possible, but small enough to capture a possible pulse in the integration interval. A value for the step size of 0.1-0.3 times the pulse width, preferably 0.2, may be an acceptable value. The step size consequently defines the number of delay values required to cover the whole code period, though the present invention is not limited to any particular number of delay values used in the method.

In FIG. 6, a flow diagram of a process of fine-tuning the selected delay value is shown in accordance with a further embodiment of the present invention.

In step S6, after having selected a delay value in step S4 of FIG. 3, device 1 may define a plurality of different fine delay values deviating from the selected delay value. The fine delay values may have a step size with respect to one another that is smaller than the step size used for the delay values in step S3 of FIG. 3. As such, a higher resolution can be achieved. Furthermore, the range of deviation from the previously selected delay value in step S4 of FIG. 3 may be selected to be smaller than the length of the entire code period, since the initially selected delay value provides a coarse estimation of the optimum delay value for synchronicity. This prevents or limits excessive and unnecessary determination of integration values far removed from the initially selected delay value, thereby limiting the time required even for high resolution (i.e. fine) synchronization. Instead, fine delay values may be selected locally to the extreme found in step S4 of FIG. 3. It is noted that once the device is synchronized coarsely, i.e. after the first synchronization of steps a) to e) as described hereabove or in relation to FIG. 3, data may be modulated in and demodulated from the signal. This may be performed while the second pass of synchronization, i.e. the fine synchronization described with respect to FIG. 6, is performed.

In step S7, device 1 selects at least one integration interval among the plurality of integration intervals for integrating signal 10. Since the start of the code period is already coarsely determined, there is no need to integrate over the whole code period. Instead, by using less integration intervals than the code length, only some pulses are integrated. As an example, the number of integration intervals used corresponds to a chip rate. Nevertheless, the present invention does not exclude integrating over a single integration window, or over the whole code period, for example by selecting all integration intervals in the integration window.

In step S8, similarly to step S4, for each fine delay value, device 1 shifting the at least one selected integration interval with respect to the signal according to the respective fine delay value, and determines a corresponding fine integration value based on a difference between a first integral of the signal over the first integration range(s) of the selected at least one integration interval and a second integral of the signal over the second integration range(s) of the selected at least one integration interval.

Finally, in step S9, device 1 selects, as the fine-tuned delay value, a fine delay value among the plurality of fine delay values corresponding to an extreme of the determined integration values.

In the method described above with reference to FIG. 6, a two-step process is implemented. First, a coarse estimation is obtained for the delay value required for synchronicity, and subsequently a fine estimation is obtained. As will be appreciate by the person skilled in the art, this process can easily be extended to a three-step process, or even more than three steps, depending on the required accuracy of synchronicity in the specific application. The present invention thus also does not exclude such three or more step processes.

Device 1 may be configured to perform steps S6-S9 using for example processing unit 4, processing circuitry in receiving unit 2, or both.

After synchronization, device 1 can use receiving unit 2 in various applications, including but not being limited to those described below with reference to FIGS. 7-10. In particular, once receiving unit 2 is synchronized to the signal using the synchronization method according to the present invention, a second signal including can be provided by the external device or external object. The second signal is synchronous to the signal used for synchronization, so that receiving unit 2 can accurately extract information therefrom.

The synchronization process may terminate once receiving unit 2 is synchronized. For example, device 1 is configured to transmit, using transmitting unit 3, an acknowledgement of synchronization to the external device. Alternatively, synchronization may take place during a synchronization period of predetermined length that is sufficient for device 1 to synchronize receiving unit 2. A transition from the synchronization period may be indicated by the external device using a particular bit pattern different from the bit pattern used during synchronization. For example, a sign of the bit may switch to indicate termination of the synchronization period.

The second signal may be similar to the signal used for synchronization. For example, both signals may employ a same code period and code length, though this need not be the case. For example, the second signal may have a different code period or code length that is an integer fraction or integer multiple of the code period of the signal used for synchronization. The specification of the second signal may be predetermined for certain applications, or may be communicated to device 1 after completing synchronization by embedding information into the second signal using a known modulation technique and using the same code period and code length as used for the signal. An advantage may be to use a shorter code length for synchronization, since synchronization time may be generally shorter than a use time of device 1 for communication, for example. By using a shorter code length for synchronization, the synchronization time can be reduced while having only a limited impact on electromagnetic interference due to the short synchronization time, for example.

After performing the synchronization method, receiving unit 2 may over time lose synchronicity with respect to the second signal. For example, clock drift may occur in receiving unit 2, which may slowly cause a mismatch between the expected pulse position and the actual pulse position in the second signal. Accordingly, the selected delay value may be adjusted slightly. For example, a full re-synchronization using the method according to the present invention may be performed.

Alternatively, according to a further embodiment of the present invention, the second signal may be used to correct the delay value based on an integration value of a plurality of consecutive pulses of the second signal. For example, based on the integration value for a series of consecutive pulses, for instance corresponding to three bits (i.e. three times the chip rate), a direction and optionally magnitude of the required shift can be determined. The delay value can then be shifted accordingly. The frequency of correcting the delay value may be selected based on the magnitude of the required shifts. For example, when a highly accurate clock signal is used, it may not be necessary to continuously correct the delay value, thereby saving computational power. The correction of the delay value may also be a measure for changes in, for example, relative distance between device 1 and the external device or object, or to the relative distance itself, as described below with reference to FIGS. 7 and 9.

In FIG. 7, a schematic diagram of an operation of device 1 is shown in accordance with an embodiment of the present invention. In this application, ranging can be implemented by device 1. In particular, device 1 may transmit the signal for synchronization towards a target object 30, which can reflect the signal back to device 1, depending on material properties of target object 30. The reflected signal may in turn be received by receiving unit 2, and the synchronization method described above with reference to FIG. 3 can be carried out. Thus, the signal reflected by the target object 30 may function as the signal for synchronization of receiving unit 2. The same signal may subsequently be used as the second signal.

A time of flight of the second signal from device 1 to target object 30 and back may be indicative of a general distance between device 1 and target object 30, as will be appreciated by the skilled person. The time of flight may in principle be determined by timing sending and reception, but can also be determined from the delay required to synchronize to the signal. This opens up another application in which the target object 30 is a transmitter of the signal. The required delay to synchronize in that case is a measure for the mutual distance between the device 1 and the transmitter 30. The device 1 need not a have a transmitter for this particular application, as no signal needs to be sent to the transmitter 30. Further, the determined mutual distance may be used together with position information of the device 1 or the transmitter 30 to determine a position of the one or the other. If multiple transmitters of known location are used, multilateration can be performed to determine the position of the device. This may require the transmitters to be synchronized or to operate at a constant phase difference. Moreover, when a position of target object 30 changes with respect to device 1, the delay value required for synchronicity of receiving unit 2 may have to be adjusted accordingly. The change in delay value may then function as a measure for changes in relative distance between device 1 and target object 30.

Of course the target object 30 may also be a transceiver which receives the signal, synchronizes to it, and transmits back a synchronous second signal. In that case, the delay required at the device to synchronize is also indicative of a mutual distance, which can be used as described above in position or localization applications.

In FIG. 8, a schematic diagram is shown of an operation of device 1 according to another embodiment of the present invention. In this application, device 1 may be configured to perform data communication with an external device 40.

First, device 1 may synchronize its receiving unit 2 based on a signal received from external device 40, using the synchronization method according to the present invention. Subsequently, external device 40 may transmit the second signal, and the second signal may be a data signal including a payload. Device 1 may extract data from the second signal by receiving the second signal with the synchronized receiving unit 2, and by subsequently demodulating and processing the received signal. Demodulation may be performed while the delay is fine-tuned as described with reference to FIG. 6.

Device 1 may comprise first receiver 2a and second receiver 2b. First receiver 2a may have a first communication range r1, whereas second receiver 2b may have a second communication range r2 greater than first communication range r1. For example, first receiver 2a is a Li-Fi receiver, and second receiver 2b is a UWB receiver that may typically have a greater range than Li-Fi receiver. Here, it is noted that range does not necessarily imply a ‘distance’. For example, with a Li-Fi receiver, a line-of-sight from external device 40 to device 1 is typically required to be able to communicate, whereas line-of-sight is typically not needed when using UWB signals, which can penetrate objects depending on material properties. As a result, the communication range for a typical Li-Fi receiver may be relatively limited with respect to the communication range for a typical UWB receiver. On the other hand, as will be appreciated by the skilled person, a larger bandwidth and thus a higher communication rate may typically be achieved with Li-Fi when compared to UWB.

It is noted that the communication ranges may similarly apply to external device 40, which may in turn comprise a transmitting unit, for example including a Li-Fi transmitter and/or a UWB transmitter. For bi-directional communication, both device 1 and external device 40 should be in range of one another, and both device 1 and external device 40 should comprise a transmitting unit and a receiving unit.

It may be that external device 40 is within second communication range r2 but not within first communication range r1. In that case, synchronization of receiving unit 2 with respect to a signal from external device 40 can be achieved using second receiver 2b. For example, synchronization and subsequently communication can be performed using the UWB receiver based on the UWB signal transmitted by the UWB transmitter of external device 40. On the other hand, if external device 40 is within first communication range r1 as well as within second communication range r2, either the Li-Fi receiver or the UWB receiver can be used.

Since both Li-Fi based communication and UWB based communication can be pulse-based, it is possible for device 1 to synchronize, at least coarsely, first receiver 2a before external device 40 is within first communication range r1. For example, external device 40 may be configured to transmit a UWB signal as the signal for synchronization, and device 1 may then receive the signal using second receiver 2b. In that case, the synchronization method in accordance with the present invention can already be performed for first receiver 2a despite external device 40 not being in range for first receiver 2a to receive a Li-Fi signal therefrom. After synchronization, once external device 40 enters first communication range r1, communication may start using Li-Fi, or, if communication already started using UWB in second communication range r2, communication may be handed over from UWB to Li-Fi. This obviates the need for another synchronization period once external device 40 enters first communication range r1.

The same functionality can be achieved by a device 1 which has a receiver receptive to both UWB and Li-Fi, by operating the receiver as UWB receiver during a first period of time and as a Li-Fi receiver during a second period of time.

In FIG. 9, a localization system 100 is shown in accordance with an embodiment of the present invention. System 100 comprises device 1 and a plurality of mutually stationary and mutually synchronized transmitters 50a-50d. In this application, transmitters 50a-50d are each configured to transmit a respective signal comprising pulses spread across a code period, similarly to signal 10 shown in FIG. 2.

Device 1 is configured to determine a delay required to synchronize receiving unit 2 to each of the plurality of transmitters 50a-50d using the synchronization method in accordance with the present invention. The device 1 is not actually necessarily synchronized to any of the transmitters. Furthermore, device 1 is configured to determine, based on a difference between the selected time shifts corresponding to each transmitter 50a-50d, a position of device 1 relative to the plurality of transmitters 50a-50d based on a distance between the device 1 and each transmitter 50a-50d. In other words, device 1 can be localized relative to transmitters 50a-50d by means of the selected delays resulting from applying the synchronization method for each transmitter 50a-50d. By continuously or periodically determining a required adjustment in delay values, device 1 can be tracked with respect to transmitters 50a-50d.

FIG. 10 illustrates a situation with a simplified device 1 with a receiving unit 2 and a transmitting unit 3. A target object 30 is also illustrated. The device 1 may operate by transmitting a signal towards the object, which reflects it to the receiving unit 2. The device 1 can then determine a delay value necessary to synchronize to the signal, which indicates a distance to the object 30.

In the above, the present invention has been explained using detailed embodiments thereof. However, it should be appreciated that the invention is not limited to these embodiments and that various modifications are possible without deviating from the scope of the present invention as defined by the appended claims.

1. A method for synchronizing a receiving unit of a device to an electromagnetic signal, the signal comprising pulses spread across a length of time referred to as a code period, wherein a position of the pulses within the code period is defined by a pseudo-random code,
wherein the method comprises, by the device:
a) receiving, using the receiving unit, the signal;
b) defining an integration window having a length corresponding to the code length, and comprising integration intervals at positions within the integration window defined by the pseudo-random code, each integration interval comprising a first integration range and a non-overlapping second integration range;
c) for each of a plurality of different delay values, shifting the integration window with respect to the signal with the respective delay value and determining a corresponding integration value based on a difference between a first integral of the signal over the first integration ranges and a second integral of the signal over the second integration ranges;
d) selecting a delay value among the plurality of delay values corresponding to an extreme of the determined integration values; and
e) synchronizing the receiving unit to the signal using said selected delay value.

2. The method according to claim 1, further comprising, prior to or after step e), fine-tuning the selected delay value by:
f) defining a plurality of different fine delay values deviating from the selected delay value;
g) selecting at least one integration interval among the plurality of integration intervals;
h) for each fine delay value, shifting the at least one selected integration interval with respect to the signal according to the respective fine delay value, and determining a corresponding fine integration value based on a difference between a first integral of the signal over the first integration range(s) of the selected at least one integration interval and a second integral of the signal over the second integration range(s) of the selected at least one integration interval; and
i) selecting, as the fine-tuned delay value, a fine delay value among the plurality of fine delay values corresponding to an extreme of the determined fine integration values.

3. The method according to claim 2, wherein the selected at least one integration interval is a plurality of selected integration intervals, the amount of which is smaller than the code length, or wherein the selected at least one integration interval is exactly one integration interval among the plurality of integration intervals in the integration window.

4. The method according to claim 1, wherein a width in time of the first and second integration interval corresponds to a width in time of the pulses.

5. The method according to claim 1, wherein the receiving unit comprises a first receiver, and wherein step e) comprises synchronizing the first receiver.

6. The method according to claim 5, wherein step a) is performed by the first receiver.

7. The method according to claim 5, wherein the receiving unit further comprises a second receiver, and wherein step a) is performed by the second receiver,
wherein, preferably, step e) further comprises synchronizing the second receiver.

8. The method according to claim 1, wherein the code period is divided into a plurality of time-intervals, each time-interval comprising a plurality of sub-intervals, wherein each time-interval comprises a pulse positioned in one of the plurality of sub-intervals thereof in accordance with the pseudo-random code.

9. A method of operating a device comprising a receiving unit, the method comprising:
synchronizing the receiving unit using the method of claim 1; and
receiving, using the synchronized receiving unit, a second signal including pulses, said second signal being synchronous to the signal.

10. The method according to claim 9, further comprising determining integration values for a plurality of consecutive pulses of the second signal based on the selected delay value and one or more delay values deviating therefrom to determine a direction and optionally a magnitude in which the selected delay value should be adjusted to maintain synchronicity, and adjusting the selected delay value by the determined amount.

11. The method according to claim 9, wherein the second signal is a data signal, and wherein the method further comprises processing the data signal to extract data therefrom,
wherein, preferably, a modulation scheme such as on-off-keying, ‘OOK’, is employed for the data signal to embed data therein, and wherein the method comprises demodulating the data signal.

12. The method according to claim 9, wherein the second signal reflected by a target object, and wherein the method comprises determining a relative distance between the device and the target object based on the selected delay value,
wherein preferably the device further comprises a transmitting unit, wherein the method comprises, by the transmitting unit, transmitting the signal,
wherein, preferably, the transmitting unit and the receiving unit are combined in a transceiver unit.

13. The method according to claim 9, in so far as depending on claim 5, wherein the first receiver is a Li-Fi receiver or an ultra-wideband, ‘UWB’, receiver, preferably a Li-Fi receiver.

14. The method according to claim 9, in so far as depending on claim 7, further comprising receiving, by the second receiver, the second signal using the selected delay value or, if applicable, the fine-tuned delay value selected for the first receiver.

15. The method according to claim 14, wherein the second receiver is a Li-Fi receiver or a UWB receiver, preferably an UWB receiver.

16. The method according to claim 14, wherein the first receiver has a first communication range and wherein the second receiver has a second communication range greater than the first communication range, wherein the second signal is received from an external object or external device,
wherein the method comprises, by the device: selecting one or both of the first receiver and the second receiver to receive the second signal when the external object or external device is within the first communication range, and select the second receiver to receive the second signal when the external object or external device is within the second communication range but not within the first communication range.

17. The method according to claim 9, wherein the pulses in the second signal are spread across a second code period, wherein a number of pulses in the code period for the signal is equal to or larger than a number of pulses in the second code period for the second signal.

18. A device comprising a receiving unit, wherein the device is configured to perform the method as defined in claim 1, the device optionally comprising a transmitting unit.

19. (canceled)

20. A localization system, comprising:
a device as defined in claim 18; and
a plurality transmitters each having a predetermined location,
wherein the transmitters are each configured to transmit a respective signal comprising pulses spread across a length of time referred to as a code period, wherein a position of the pulses within the code period is defined by a pseudo-random code, and
wherein the device is configured to:
determine the delay required to synchronize the receiving unit to each of the plurality of transmitters using the method as defined in any of the claims 1-8; and
determine, based on a difference between the determined delays corresponding to each transmitter, a position of the device relative to the plurality of transmitters.

21. A localization system, comprising:
a device as defined in claim 18; and
a one or more transceivers,
wherein the device or each of the one or more transceivers is configured to transmit a respective signal comprising pulses spread across a length of time referred to as a code period, wherein a position of the pulses within the code period is defined by a pseudo-random code, the signal constituting a request,
wherein the other of the device or the one or more transceivers is configured to synchronize to the signal using the method as defined in claim 1,
wherein, after synchronizing, the other of the device or the one or more transceivers is configured to transmit to the device or the one or more transceivers, a further signal comprising pulses, said further signal being synchronized to the signal, as a response, and
wherein the device or the one or more transceivers are configured to determine a delay required to synchronize to the further signal according to the method of claim 1, and to determine a mutual distance between the device or the one or more transceivers on the one hand and the other of the device and the one or more of transceivers on the other hand based on the required delay.
